(19) United States
(12) Patent Application Publication
(10) Pub. No.: US 2011/0286399 A1
(43) Pub. Date: Nov. 24, 2011

(54) DEVICE AND METHOD FOR CONTROLLING UPLINK DATA TRANSMISSION

(75) Inventors: Thomas Chapman, Southampton (GB); Terence Dodgson, Southampton (GB); Malgorzata Wimmer, Wroclaw (PL); Jakub Gorzynski, Kwieciszewo (PL)

(73) Assignee: NOKIA CORPORATION, Espoo (FI)

(21) Appl. No.: 13/145,952

(22) PCT Filed: Jan. 22, 2009
(86) PCT No.: PCT/EP09/50703

§ 371 Date: Jul. 22, 2011

(51) Int. Cl. H04W 52/04; H04W 4/00

(52) U.S. Cl. 370/328

(57) ABSTRACT

Device and method to recognize and report the source of interference relate to data transmission between a user terminal and a base station, wherein a pilot signal is transmitted from all antenna assemblies of the user terminal simultaneously, said pilot signals from the user terminal are received by the base station, wherein the base station sends a power control command to the user terminal, corresponding to each of the pilot signals, and wherein the user terminal chooses on receipt of the power control commands, which antenna assembly of the user terminal is used to transmit the next uplink data.

### TECHNICAL FIELD OF THE INVENTION

The present invention relates to the technical field of communication networks. In particular the present invention relates to a user terminal and a device for wireless communication, a method of transmitting data, and to a program element.

### BACKGROUND OF THE INVENTION

Spectrum scarcity has resulted in the demand for technologies which can make more efficient use of allocated bandwidths.

Multiple Input Multiple Output (MIMO) technology is reported to be such a technology, one which attempts to exploit multipath propagation effects to provide higher data throughput, whilst remaining spectrally efficient.

The generic term MIMO is sometimes used to refer to a number of technologies relating to multiple antennas. These include so-called “Spatial Multiplexing”, in which multiple signals are transmitted over the same resources (Implemented in Wideband Code Division Multiple Access (WCDMA) as Double Transmit Antenna Array (D-TxAA)), “Transmit Diversity”, in which the same information is transmitted over multiple channels (WCDMA example TxAA) and beamforming techniques.

By definition, spatial multiplexing MIMO technology works with multiple signals, the generation of which will lead to more user and system interference. Receivers working in such scenarios are likely to be more complex as a consequence.

On the other hand, switching antennas on a regular basis, is known to result in enhanced signal reception because it introduces additional diversity in the received signal.

One example of a system that already employs antenna switching is Time division—synchronous code division multiple access (TD-SCDMA). Another system is so called “LTE” or “Enhanced UTRAN” (Enhanced UMTS terrestrial radio access network). These system do periodic (non-directed) antenna switching, which would experience a performance increase.

Current 3GPP WCDMA standards make use of all of these types of MIMO in the downlink (for example Transmit Diversity, TxAA, and Double Transmit Adaptive Array, D-TxAA, for High Speed Downlink Packet Access (HSDPA)). Such MIMO schemes can improve throughput in the downlink.

The following documents of the 3GPP WCDMA standards can be considered as a basis for the invention.

The document TS 25.211 of the 3rd Generation Partnership Project (3GPP); Technical Specification Group Radio Access Network; Physical channels and mapping of transport channels onto physical channels (FDD), v8.2.0, 2008-09, Release 8, may describe the characteristics of the Layer 1 transport channels and physicals channels in the FDD mode of UTRA. The main objectives of the document may be to be a part of the full description of the UTRA Layer 1, and to serve as a basis for the drafting of the actual technical specification.

The document TS 25.212 of the 3rd Generation Partnership Project (3GPP); Technical Specification Group Radio Access Network; Multiplexing and channel coding (FDD), v8.3.0, 2008-09, Release 8, may describe the characteristics of the Layer 1 multiplexing and channel coding in the FDD mode of UTRA.

The document TS 25.213 of the 3rd Generation Partnership Project (3GPP); Technical Specification Group Radio Access Network; Spreading and modulation (FDD), V8.2.0, 2008-09, Release 8 may describe spreading and modulation for UTRA Physical Layer FDD mode.

The document TS 25.214 of the 3rd Generation Partnership Project (3GPP); Technical Specification Group Radio Access Network; Physical layer procedures (FDD), V8.3.0, 2008-09, Release 8, may specify and establish the characteristics of the physicals layer procedures in the FDD mode of UTRA.

The document TS 36.211 of the 3rd Generation Partnership Project (3GPP); Technical Specification Group Radio Access Network; Evolved Universal Terrestrial Radio Access (E-UTRA); Physical Channels and Modulation, V8.4.0, 2008-09, Release 8, may describe the physical channels for evolved UTRA.

The document TS 36.212 of the 3^{rd} Generation Partnership Project (3GPP); Technical Specification Group Radio Access Network; Evolved Universal Terrestrial Radio Access (E-UTRA); Multiplexing and channel coding, V8.4.0, 2008-09, Release 8, may specify the coding, multiplexing and mapping to physical channels for E-UTRA.

The document TS 36.213 of the 3^{rd} Generation Partnership Project (3GPP); Technical Specification Group Radio Access Network; Evolved Universal Terrestrial Radio Access (E-UTRA), v8.4.0, 2008-09, Release 8, may specify and establish the characteristics of the physicals layer procedures in the FDD and TDD modes of E-UTRA.

The document TS 36.214 of the 3^{rd} Generation Partnership Project (3GPP); Technical Specification Group Radio Access Network; Evolved Universal Terrestrial Radio Access (E-UTRA); Physical layer—Measurements, v08.4.2, 2008-09, Release 8; may contain the description and definition of the measurements done at the UE and network in order to support operation in idle mode and connected mode.

### SUMMARY OF THE INVENTION

It might be an object of the invention to provide improved transmission between a user terminal and, for example, a base station. It might be another object of the invention to provide a user terminal realizing an increased data throughput.

These and other objects will be solved by the subject matter of each independent claim. Further embodiments are described in the respective dependent claims.

In general, a user terminal according to the invention, comprises at least two antenna assemblies each of which includes one antenna for transmitting signals, one power amplifier for amplifying the signals to be transmitted from the antenna, and a switch for connecting a data channel powered by the power amplifier and the antenna.

According to another embodiment of the invention, each antenna assembly further comprises a radio frequency (RF) chain, such that the user terminal is capable of transmitting one pilot signal simultaneously from each antenna.

According to yet another embodiment of the invention, the user terminal further comprises a controlling device which on receipt of transmission power control commands, decides which antenna assembly is used to transmit the next uplink data, and which is adapted to direct the data channel to a particular antenna.

According to a further aspect of the invention, a device is provided for transmitting power control commands to a user terminal, wherein the device, in general, is adapted to receive pilot signals transmitted simultaneously from all antennas of one user terminal, and to send a power control command related to each of the pilot signals.

The device according to the invention may further comprise a radio network controller and a network element, wherein a component of the power control mechanisms is managed from the radio network controller which signals a target value to the network element, relating to each antenna.

It should be noted that the device according to the invention might be a base station, a board or a chip, or another device which is capable of exchanging signals with a user terminal, wirelessly.

According to a further aspect of the invention, a method is proposed, of transmitting data between a mentioned user terminal and an also mentioned device. In general, the method comprises the steps of transmitting a pilot signal from all antenna assemblies of the user terminal simultaneously, receiving said pilot signals from the user terminal by means of the device, sending a power control command from the device to the user terminal, corresponding to each of the pilot signals, choosing on receipt of the power control commands, which antenna assembly of the user terminal is used to transmit the next uplink data.

According to another embodiment of the invention, the method may further comprise the step of adjusting the transmission power level of the antenna assembly of the user terminal on the basis of the receipt power control command related to the pilot signal from said antenna assembly.

At this, the steps of the method according to the invention may be performed in a single slot, usually. The steps may also be performed in a transmission time interval (TTI).

According to another embodiment of the invention, the method may further comprise the step of transmitting in a following slot, uplink data from the chosen antenna assembly to the device.

In other words, the user terminal will transmit in a single slot, first of all, pilot signals by means of all antenna assemblies, and furthermore, uplink data from only one of the antenna assemblies, wherein said one assembly was chosen as having the best transmission conditions, on the basis of the last but one transmitted pilot signal (in a previous slot).

According to a further aspect of the invention, a program element is provided, which when being executed by a processor is, in general, adapted to carry out: transmitting a pilot signal simultaneously from all antenna assemblies of a user terminal, choosing on receipt of power control commands, which antenna assembly is used to transmit the next uplink data, and transmitting uplink data from the chosen antenna assembly, wherein a transmission power level of a data transmission may be adjusted on the basis of a receipt power control command related to the transmission of the pilot signal from the respective antenna assembly.

The program element may include a program code being stored on a computer-readable medium.

That is, by means of the program element each transmission power level may be adjusted on the basis of a receipt transmission power control command related to the transmission from the respective antenna.

Therefore, the invention relates to a program element for a processing device, such that the method according to the invention might be executed on an appropriate system. The program element is preferably loaded into a working memory of a data processor. The data processor is thus equipped to carry out the method of the invention. Further, the program code of the program element may be stored on a computer readable medium, such as a CD-Rom. However, the program element may also be presented over a network like the worldwide web and can be downloaded into the working memory of a data processor from such a network.

It has also to be noted that exemplary embodiments of the present invention and aspects of the invention have been described with reference to different subject-matters. In particular, some embodiments have been described with reference to apparatus type claims whereas other embodiments have been described with reference to method type claims. However, a person skilled in the art will gather from the above and the following description that unless other notified in addition to any combination between features belonging to one type of subject-matter also any combination between features relating to different subject-matters in particular between features of the apparatus claims and the features of the method claims may be considered to be disclosed with this application.

These and other aspects of the present invention will become apparent from and elucidated with reference to the embodiments described hereinafter.

Exemplary embodiments of the present invention will be described in the following with reference to the following drawings.

### BRIEF DESCRIPTION OF THE DRAWINGS

FIG. 1 shows a schematically representation of an exemplary user terminal having two antenna assemblies.

FIG. 2 shows a flow chart illustrating the step of a method according to the invention.

FIG. 3 shows steps of a method according to the invention, related to a user terminal and a base station, respectively.

FIG. 4 shows an illustration of transmission packets between a user terminal and a base station in a series of slots.

FIG. 5 shows an enlarged illustration of two slots including a change from one antenna assembly to another.

### DETAILED DESCRIPTION

The illustration in the drawings is schematic. In different drawings, similar or identical elements are provided with the same reference signs.

The concept proposed herein, considers the uplink of a cellular system such as 3GPP WCDMA when utilizing HSUPA (High Speed Uplink Packet Access). In particular, the invention makes use of antenna diversity.

The invention is also related to Transmit diversity and “classical” Wideband Code Division Multiple Access (WCDMA) and the UL channel design which allows for joint operation of these two technology areas, focusing on the throughput increases that can be achieved by switching antennas based on associated channel conditions in the uplink.

Since there are less implementation restrictions when considering multiple antennas for base stations, research has mostly focused on MIMO antennas and antenna arrays at the base station of cellular systems. The size of the user equipment or handset limits the number of antennas that can be deployed typically to one or two (when considering typical mobile communications operating frequencies and associated propagation environments). Never-the-less, certain MIMO techniques can still be deployed working within the limitations—one such technique being Transmit Antenna Array Diversity(TxAA).

With current, single antenna, mobiles, space diversity cannot be easily exploited. Emerging technologies allow for multiple antennas, appropriately spaced, and utilizing antenna switching or Tx antenna weighting. The invention focuses in particular on antenna switching based Tx channel diversity.

Non-directed (periodic) antenna switching is reported to give an increase in performance, although it is not an obvious conclusion since this blind manner of switching may mean that changing antennas is as likely to result in going from a good channel to a bad one as it is to result in going from a bad channel to a good one. Thus, for non-directed antenna switching, the diversity exploitation is likely to be a consideration of fading rate, slot size, data rate etc.

It is, perhaps, more obvious that there will be a performance increase if a way could be found to measure the channels associated with each antenna and to always switch to the antenna which has the best channel associated with it. This then is the concept associated with directed antenna switching for Uplink 3GPP WCDMA.

In the following, an exemplary embodiment of the invention will be described with reference to the drawings.

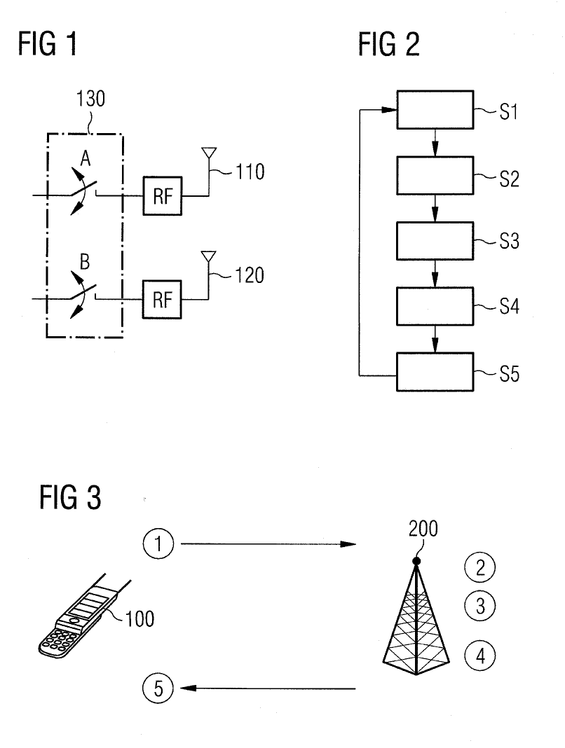

FIG. 1 shows a schematic illustration of a user terminal having two antenna assemblies, wherein the power amplifier of each assembly is not shown in FIG. 1. Accordingly, two antenna switches 130, two RF chains and two antennas 110, 120 are depict in FIG. 1, representing two antenna assemblies.

Pilot transmission takes place from both User Terminal antennas, at the same time (in parallel) in order to determine the different channels and to then use this channel information to exploit space diversity, thereby increasing user throughput. The transmission of signals in parallel implies the use of two distinct RF chains, which indicates that Pilot channels are always transmitted at the same time, whereas when data is transmitted only one switch would be closed (i.e. the one corresponding to the best antenna at that time).

This conceptual algorithm flow (in absence of soft handover) is given in FIGS. 2 and 3.

The flow chart in FIG. 2 illustrates a method according to the invention. In one slot, all steps S1 to S5 are performed, and the steps will be repeated in a following slot.

In FIG. 3, the communication between a user terminal 100 and a base station 200 is illustrated, wherein the numerals 1 to 5 symbolize the numbers of the steps of the method related to the device at which the step is performed, and the arrows show the direction of transmission.

In detail, in step S1 one pilot signal will be transmitted from all of the antenna assemblies of the user terminal 100. That means, that a controlling unit of the user terminal will close the switches of all antenna assemblies, at the same time, to transmit the pilot signal from all antennas simultaneously.

In step S2, a base station 200, firstly, receives said pilot signals from the user terminal. After estimating the channel conditions from the pilot signals at step S3, the base station sends a power control command to the user terminal, corresponding to each of the pilot signals, in step S4.

Then in step S5, the user terminal, i.e. the controlling unit of the user terminal chooses on receipt of the power control commands, which antenna assembly of the user terminal is used to transmit the next uplink data.

The arrow from the rectangle S5 to the rectangle S1 in figure symbolizes, that in the following step S1, the user terminal will, again, transmit pilot signals from all antenna assemblies, but is also capable to transmit data from one of the antenna assemblies.

It will be understood, that in the user terminal the transmission power level of the antenna assembly may be adjusted on the basis of the receipt power control command related to the pilot signal from said antenna assembly.

The data (e.g. E-DPDCH) is sent on this antenna. The Base Station receives each Pilot, deploying appropriate channel estimation to determine the different channel conditions. The Base Station also decodes the data. The Base Station then runs a decision algorithm to decide on the appropriate TPC command for the User Terminal to use in the next slot for each antenna. The TPC command is calculated to try and ensure that transmissions from either antenna would result in a constant Signal to Noise Ratio (SNR) at the base station. This command is then sent to the User Terminal.

At the user terminal, the TX power for each pilot will depend on the instantaneous pathloss to the basestation; if the pathloss worsens then the power control loop will increase the TX power in order to maintain receive SNR. Thus, by examining the TX power for each antenna, the terminal is able to determine the antenna with the lowest pathloss and use that antenna for transmitting the data channel.

In order for the Base Station to be able to determine from which User Terminal Antenna data transmissions have come from, a method is required to provide appropriate identification. One method would be to provide each antenna with two unique Pilot sequences, one to be used when the data is sent from the same antenna that the pilot is sent from and one when it isn't.

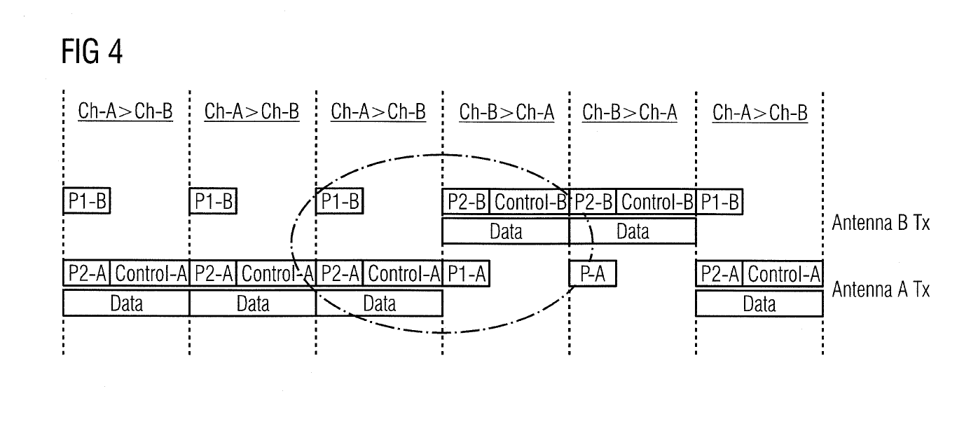

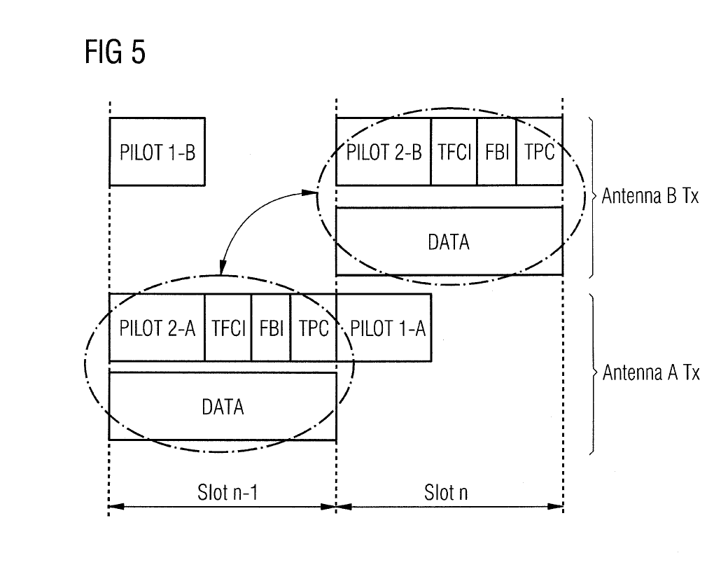

An example of possible transmissions per slot are indicated in FIG. 4, where Ch-A and Ch-B indicate Channel A and Channel B, associated with Antenna A and Antenna B respectively. P1-A is the Pilot that Antenna A transmits when it has been deemed (in the previous slot) to be the worse channel (Antenna B transmits Pilot P2-B when this is the case). Similarly P1-B is the Pilot that Antenna B transmits when it has been deemed (in the previous slot) to be the worse channel (Antenna A transmits Pilot P2-A when this is the case).

The data channel, E-DPDCH is sent with a fixed power offset, beta_ed with respect to the relevant control channel, regardless of which antenna it is transmitted from.

Since the use of four pilot sequences in the manner described is mutually exclusive, it would be possible to implement a similar scheme whereby only three pilot sequences are used—since only one antenna need indicate that it has data also (the other antenna will then, inherently, have no data to transmit).

The User Terminal would make the ultimate decision of which antenna to use since it will have access to the absolute power levels being used. The antenna requiring the lowest transmit power would be used, which corresponds to the “best channel”.

The trade-off between introducing more interference and achieving enhanced channel estimation by having a longer Pilot sequence on the antenna which is not transmitting any data might also be considered.

When the User Terminal has only one transmit chain (in particular one power amplifier), CPC like techniques may be used to keep the signal to interference ratio approximately constant for both antennas. A periodic brief switch to the non transmitting antenna would be made in order to update the power control loops, using the same principle as DPCCH gating for CPC. The UE can monitor the TX power requirements on the two DPCCHs. When an antenna switch is made for the data channel, a resynchronisation may be necessary (although the need to sometimes switch from one antenna to the other simply for resynchronisation could lead to some throughput loss).

Therefore, modifications to the uplink are provided to allow for Directed Antenna Switching by transmitting Unique Pilots from each antenna. In particular, a user terminal behaviour according to which the user terminal accepts independent transmission power commands for the two antenna chains and then decides which antenna to use for data transmission, dependent on the relative transmission levels.

Further, means are provided for the base station to determine from which antenna the pilot has been sent.

Finally, means are provided to determine whether or not there is further control and data transmitted in parallel with the received Pilot, wherein this may be by means of a signalling bit, detection of an alternative pilot sequence or blind detection of the data.

As a summary, the following main aspects are covered by the invention:

The method of Uplink Antenna Switching described requires the use of Unique Pilots, enabling exploitation of Transmit Diversity leading, ultimately, to an increase in system throughput.

The two Uplink Pilot signals would have to be transmitted in a unique way, in order to be able to identify from which antenna each was sent. The advantage of using unique Pilots would be for automatic antenna identification, and for the obvious use of channel estimation/equalization.

Switching is done on a slot basis, but the concept would also have application to working on a transmission time interval (TTI) basis. The advantage of working on a slot basis would be more immediate control, working at the TTI would not lead to such a fast response, but could reduce complexity. On the other hand, TTI level switching could enable antenna detection through the decoding of a data channel.

Independent power control loops (one for each antenna) would be required for two separate RF chains, both dimensioned to transmit up to the maximum user terminal equivalent isotropic radiated power.

It would be possible to apply the invention when only one RF chain (in particular one power amplifier) if “fly-wheeling” (in a similar manner to CPC) were allowed between slots where no data is transmitted on that particular antenna, ensuring that this “fly-wheeling” is not carried out for too long a period without having a re-synchronizing/power update process every so often.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

It should also be noted that reference signs in the claims shall not be construed as limiting the scope of the claims.

### Acronyms and Terminology

3GPP 3^{rd} Generation Project Partnership

Ch-A Channel A

Ch-B Channel B

CPC Continuous Packet Connectivity

DPCCH Dedicated Physical Control Channel

DPDCH Dedicated Physical Data Channel

D-TxAA Double Transmit Antenna Array

E-DPCCH Enhanced-Dedicated Physical Control Channel

E-DPDCH Enhanced-Dedicated Physical Data Channel

E-DCH Enhanced-Dedicated Channel

FBI Feedback Indicator

HSUPA High Speed Uplink Packet Access

MIMO Multiple Input Multiple Output

P1-A (unique) Pilot 1 for antenna A

P2-A (unique) Pilot 2 for antenna A

P1-B (unique) Pilot 1 for antenna B

P2-B (unique) Pilot 2 for antenna B

PHY Physical

Rel 7 Release 7 (of 3GPP standards)

RF Radio Frequency

Rx Receiver

SHO Soft Hand Over

SNR Signal to Noise Ratio

TFCI Transmission Format Combination Indicator

TPC Transmit Power Control

TTI Transmission Time Interval

Tx Transmitter

TxAA Transmit Antenna Array

UMTS Universal Mobile Telecommunications System

WCDMA Wideband Code Division Multiple Access

1-12. (canceled)

13. A user terminal comprising:
at least two antenna assemblies,
wherein each antenna assembly comprises one antenna for transmitting signals, and a switch for connecting a data channel and the antenna.

14. The user terminal of claim 13, wherein each antenna assembly further comprises a radio frequency chain, such that the user terminal is capable of transmitting one pilot signal simultaneously from each antenna.

15. The user terminal of claim 13, wherein the user terminal further comprises a controlling device which decides on receipt of transmission power control commands, which antenna assembly is used to transmit the next uplink data, and which is adapted to direct the data channel to a particular antenna.

16. A device for transmitting power control commands to a user terminal, the device being adapted to receive pilot signals transmitted simultaneously from all antennas of a user terminal, and to send a power control command corresponding to each of the pilot signals.

17. The device of claim 16, further comprising a radio network controller and a network element, wherein a component of the power control mechanisms is managed from the radio network controller which signals a target value to the network element, relating to each antenna.

18. A method of transmitting data between a user terminal and a device, the method comprising:
transmitting a pilot signal from all antenna assemblies of the user terminal simultaneously,
receiving said pilot signals from the user terminal by means of the device,
sending a power control command from the device to the user terminal, corresponding to each of the pilot signals,
choosing on receipt of the power control commands, which antenna assembly of the user terminal is used to transmit the next uplink data.

19. The method of claim 18, the method further comprises:
adjusting the transmission power level of the antenna assembly of the user terminal on the basis of the receipt power control command related to the pilot signal from said antenna assembly.

20. The method of claim 18, wherein the method is performed in a single slot.

21. The method of claim 18, the method further comprises transmitting in a following slot, uplink data from the chosen antenna assembly to the device.

22. A program element, which when being executed by a processor is adapted to carry out:
transmitting a pilot signal simultaneously from all antenna assemblies of a user terminal,
choosing on receipt of power control commands, which antenna assembly is used to transmit the next uplink data,
transmitting uplink data from the chosen antenna assembly.

23. The program element of claim 22, wherein a transmission power level of a data transmission is adjusted on the basis of a receipt power control command related to the transmission of the pilot signal from the respective antenna assembly.

24. The program element of claim 22, wherein the program element includes a program code being stored on a computer-readable medium.
